(19) United States
(12) Patent Application Publication
(10) Pub. No.: US 2005/0107038 A1
(43) Pub. Date: May 19, 2005

(54) Automatic connection of a mobile device to a wireless network

(76) Inventor: Daryl D. Coutts, Edmonton (CA)

Correspondence Address: THOMPSON LAMBERT;SUITE 703D, CRYSTAL PARK TWO, 2121 CRYSTAL DRIVE, ARLINGTON, VA, 22202, US

(21) Appl. No.: 11/038,249

(22) Filed: Jan. 21, 2005

(51) Int. Cl. H04B 7/00

(52) U.S. Cl. 455/41.2

(57) ABSTRACT

A novel method for automatically connecting a mobile device to a wireless network is presented. The goal of the invention is to provide a rapid wireless network connection for a mobile device at a low cost with minimal user interaction. The method focuses on adjusting the time between network connection attempts when the mobile device is not connected to a network. Once a network connection is established, the method idles, simply monitoring the network connectivity of the mobile device. When the mobile device disconnects from a network, the connection attempt cycle is once again enabled.

### BACKGROUND OF THE INVENTION

This invention relates to automatic connection of mobile devices to wireless networks.

With the proliferation of wifi networks, it is possible for wireless mobile devices such as PDAs, to function not only as traditional email devices but also as real-time communication devices providing voice and instant messaging capability. Once their mobile device is connected to a wireless network, people can receive incoming voice over IP telephone calls and instant messages.

People are used to cellphones automatically connecting to the cellphone network. People will expect their mobile devices to automatically connect to their desired wireless networks. What is needed is an efficient method to manage the network connect and disconnect process in a wireless enabled mobile device. This method must facilitate rapid connection when a desired network comes into range, it should require little user interaction, it must handle disconnection events, it should minimize scan pollution, it should not deplete the battery of the mobile device too quickly, and it should not overly expose the user to rf radiation. Once the mobile device is connected to a network, the method should idle and let the operating system, wireless chip set or other applications on the mobile device handle the network connection.

A good solution for automated connection to 802.11 networks has not been found yet because typically the user device has not been used as a communication device. The traditional scenario was an 802.11 equipped laptop which the user would set on a table and go through a manual power up and network connect sequence. Automatic wifi connection in this scenario did not add much value because the user still had to put their laptop on a desk, flip up the screen and press the power button.

The current solution for automated connection to wireless networks by mobile devices, such as PDAs, is to continuously monitor for desired networks and attempt a connection when a desired network is in range. This solution is taken from the old laptop scenario when it was assumed the user would manually activate the wireless card in the laptop only when they knew a desired network was nearby. The problem with using this solution in mobile devices is that the continuous monitoring requires scanning for networks. This scanning is typically an active process, whereby the wireless enabled mobile device issues broadcast probe requests to which nearby networks respond. Thus, when a mobile device is not in range of a desired network, the continuous scanning would unnecessarily expose the user to rf radiation. Further, this scanning causes nearby networks to respond to the probe requests, reducing network bandwidth.

A step to improving performance is taught by Krantz in US2004/0120278. “If the device has not associated to a network, the scanning engine 202 instructs the NIC 201 to scan normally (step 314)” and “The scanning engine 202 instructs the NIC 201 to scan periodically using the default scanning interval (step 314).” Krantz indicates a default scanning interval of 60 seconds in one embodiment. Coupling Krantz's scanning technique with a connection attempt methodology will provide a rapid network connection when a desired network comes into range. However, if a mobile device is stationary and out of range of a desired network, Krantz's technique will still result in wasted scanning at the fixed 60 second default scanning interval.

Ayyagari in US2002/0176366 scans for a desired network and if none is available “. . . the system waits for a few minutes 296 before again looking for the appearance of infrastructure networks 292.” Ayyagari's technique will not provide a rapid network connection if “a few minutes” is five minutes or more. If “a few minutes” is two minutes or less, Ayyagari's technique will result in a rapid network connection at the cost of wasted scanning when the mobile device is out of range of a desired network.

A manual method is not attractive either. When a user approaches one of their desired networks, they do not want to have to retrieve their wireless enabled mobile device from their backpack or pocket, remove the stylus, tap on the screen a few times to activate the wireless connection sequence. Similarly, when a user leaves the range of a network, they do not want to have to retrieve their mobile device from their backpack or pocket, remove the stylus, tap on the screen a few times to deactivate the wireless connection sequence. It is even possible the user may not even know that they are in range of one of their desired networks, so they would not activate the wireless connection sequence and then they might miss a voice over ip phone call.

Alone in US2004/0110530, suggests using a movement sensor in the mobile device. When the movement sensor detects that the device has moved it signals the control program on the device that movement has occurred. The control program then powers up the wireless network interface module and instructs the wireless network interface module to scan. If a desired network is nearby, the control program directs the wireless network interface module to connect, otherwise it powers off the wireless network interface module. The main problem with this implementation is the extra monetary cost and power cost of the movement sensor. Whether you use a mercury switch or a gps module to detect movement, it is still extra cost. Also, existing PDAs cannot benefit from this implementation without being retrofitted with movement sensors.

Sometimes a reference will discuss a connection attempt methodology, but will not discuss the stimulus to initiate the process. Thus these methodologies do not handle automatic connection and do not handle the situation where the user walks away from a network and becomes disconnected. Kim, in US2004/0038707 suggests the following method: power up the wireless network interface module, attempt a connection, if no connection, power off the network interface module and repeat this sequence at a predetermined interval. What happens when a user is connected to an access point for a while and then they walk away from that access point and become disconnected? Is the wireless network interface module left on? Is it powered off? Is the connection sequence started again? Kim does not address these issues.

Patent application US2001/0023446 Balogh, describes scanning for networks a user may want to connect to, but does not consider the frequency of connection attempts.

### SUMMARY OF THE INVENTION

It is, therefore, desirable to have a method to manage the network connection attempt frequency of a wireless mobile device when it is out of range of a desired network.

According to an aspect of my invention, I propose automatically connecting a user's mobile device to one of their desired networks when the desired network comes into range. My invention provides this capability in a more power efficient way than Ayyagari in US2002/0176366 by varying the time between connection attempts. I increase the time between connection attempts when the mobile device is stationary and not connected to a network, thus reducing the user's rf exposure and reducing the power consumption of the mobile device.

According to a further aspect of my invention, there is provided a method for rapid connection to a desired network by decreasing the time between connection attempts when the mobile device is moving. Krantz in US2004/0120278 uses a fixed scan frequency when the device is not associated with an access point.

My invention can run as a background process on a mobile device. Once the mobile device is connected to an access point my method may do nothing other than check periodically that the mobile device is still connected—therefore, my method, according to this aspect of the invention, will not interfere with the roaming of the mobile device between access points on the same network. If an application on the device independently initiates a wireless connection to an access point, a device configured to carry out my method may move from the connection attempt mode to the connection monitoring mode. Similarly, if a user manually initiates a wireless connection to an access point, a device configured to carry out my method may move from the connection attempt mode to the connection monitoring mode.

A device configured to carry out an embodiment of my method may handle the situation where the mobile device has been connected to a network for some time and then the user walks away from that network and is no longer in coverage. A device configured to carry out an embodiment of my method may move from the connection monitoring mode to the connection attempt mode. Kim, in US2004/0038707 does not address this situation which in typical mobile devices will result in the wireless network interface module continuously trying to connect to its last configured network.

A device configured to carry out an embodiment of my method may incorporate a movement detection scheme using the BSSID and RSSI set point methodology reduces the cost of the device because an attitude change sensing device is not required. A device configured to carry out an embodiment of my method may be implemented on existing wireless mobile devices.

Further objects and advantages of my invention will become apparent from a consideration of the drawings and ensuing description.

Therefore, according to an aspect of my invention, the following method steps may be carried out: A network connection attempt is made. If a network connection is not achieved, the invention waits for a period of time before trying again. Once a network connection is established, the method idles, simply monitoring the network connectivity of the mobile device. When the mobile device disconnects from a network, the connection attempt cycle is once again enabled.

According to a further aspect of the invention, the method or a device configured to carry out an embodiment of my method may vary the time between wireless network connection attempts for a mobile device when the mobile device is not connected to a network. For example, initially, on a connection attempt cycle, a scan is made for nearby access points and their RSSIs. A setpoint is chosen as the BSSID with the strongest RSSI. If the setpoint RSSI changes beyond a threshold on a subsequent connection attempt cycle, the time to the next connection attempt is decreased and a new setpoint is chosen, otherwise the time to the next connection attempt is increased. This is similar to determining if the mobile device has recently moved and decreasing the time to the next connection attempt if the mobile device has recently moved and increasing the time to the next connection attempt if the mobile device has not recently moved.

According to a further aspect of the invention, if the mobile device is out of range of any wireless networks using the protocol of interest, the time between connection attempts is increased. For instance, if the protocol of interest is 802.11 and there are no 802.11 wireless networks nearby, the time between connection attempts is increased. The method, in its various aspects, media containing instructions for carrying out the method, and a device configured to carry out the method, are also claimed.

### BRIEF DESCRIPTION OF THE DRAWINGS

There will now be described preferred embodiments of the invention with reference to the drawings by way of illustration, and without intending to limit the invention to the specific embodiment disclosed, in which:

FIG. 1 is a hardware block diagram of a mobile device according to the invention;

FIG. 2 contains screenshots from a Wifi Auto-Connect application which implements the invention on an IPAQ 4150;

FIG. 3 is a software block diagram of a mobile device configured according to the invention;

FIG. 4 is a flowchart of the connection attempt cycle and connection monitoring cycle for use in an embodiment of the invention.

FIG. 5a is a flowchart of an embodiment of the method of the invention; and

FIG. 5b is a detailed flowchart of the steps in determining if there has been a change in the ability of the mobile device to communicate with an access point.

### DETAILED DESCRIPTION OF PREFERRED EMBODIENTS OF THE INVENTION

In this patent document, including the claims, the use of the word “comprising” does not exclude other elements being present and the use of the indefinite article preceding an element does not exclude more than one of the element being present.

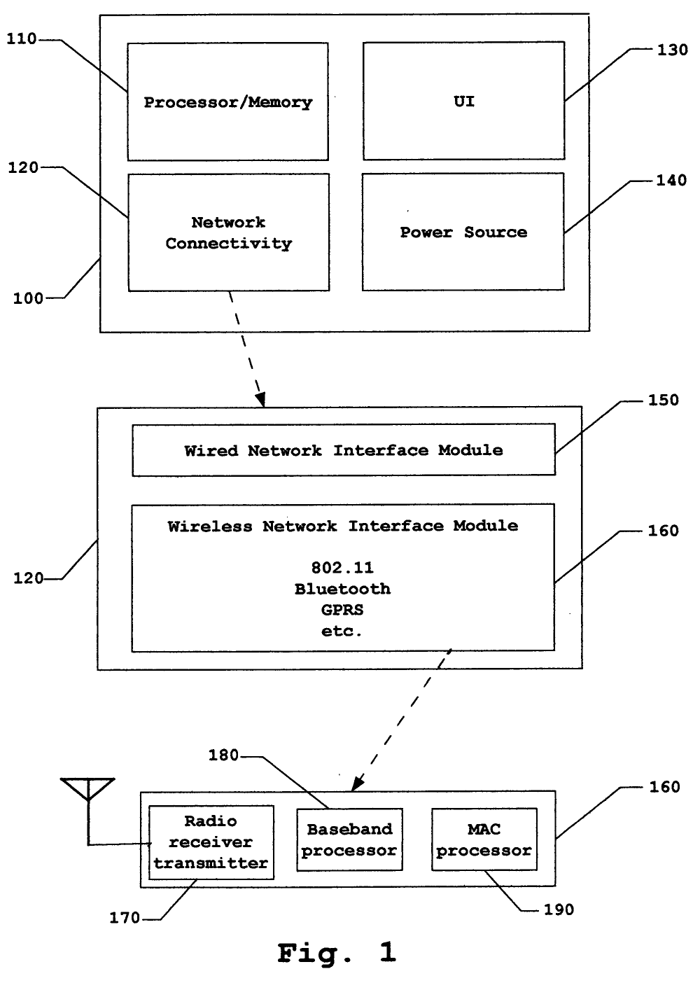

Typically, the invention will be implemented in a wirelessly enabled mobile device such as a PDA (personal digital assistant). The word “mobile device” includes any wireless enabled mobile device now known or hereafter developed. FIG. 1 shows the hardware block diagram of a typical mobile device 100 that is configured to implement the method steps of the invention. The main subsystems of the mobile device 100 include a processor/memory block 110, a UI block 130, a power source block 140 and a network connectivity block 120. The network connectivity block 120 comprises a wired network interface module 150 and a wireless network interface module 160. The wireless network interface module 160, responds to commands from the mobile device's processor 110 and implements the wireless protocol in use by the mobile device 100. The wireless network interface module 160 comprises a radio transmitter/receiver 170, a baseband processor 180 and a MAC 190. If a mobile device has more than one kind of wireless it may have more than one kind of radio transmitter/receiver 170 or more than one kind of baseband processor 180 or more than one kind of MAC 190. For instance, if a mobile device 100 has 802.11 capability and Bluetooth capability it may share the radio section 170 and have 2 different MACs 190. Not all of the modules and blocks mentioned are required to implement the invention, they are listed here to show what is typical in a mobile device. For instance, it is not a requirement that a mobile device have a UI block 130. Also, some modules could be combined and integrated into other modules. It is conceivable that in the future the wireless network interface module 160 is integrated into the processor/memory module 110.

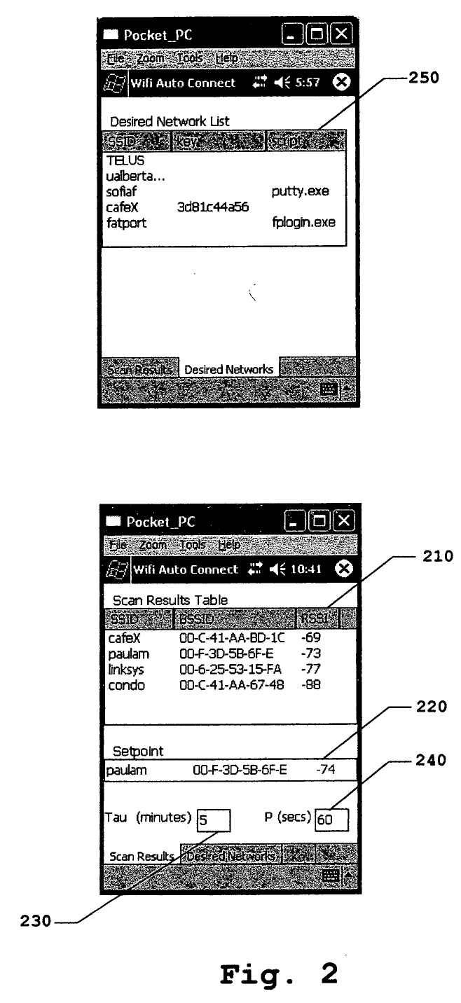

FIG. 2 shows two screen shots from a Wifi Auto-Connect application which implements an embodiment of the invention. Although shown implemented as an application, the invention could be implemented as part of a mobile device's operating system or as a background process on the mobile device or another way on the mobile device so as to achieve automatic wireless network connection. In FIG. 2, 210 is the Scan Results Table. The SSID, BSSID (MAC address) and RSSI of nearby access points are recorded in 210 when a scan is performed. (It is not required that the SSID be recorded. Other parameters received during a scan could of course be recorded as well.) 220 is the Setpoint which has been selected. It includes a BSSID, RSSI and SSID. (The Setpoint does not require both the SSID and BSSID be recorded, either would be acceptable) 230 is Tau, the period in minutes of the connection attempt cycle. 240 is P, the period in seconds of the connectivity monitoring cycle. 250 is the Desired Network List. 250 is a user editable list where the user enters the SSIDs of all the wireless networks they want their mobile device to automatically connect to. In addition, the user may enter WEP keys or other connection information for each desired network. In 250, the user can also specify a login script to run when a particular network connection is made.

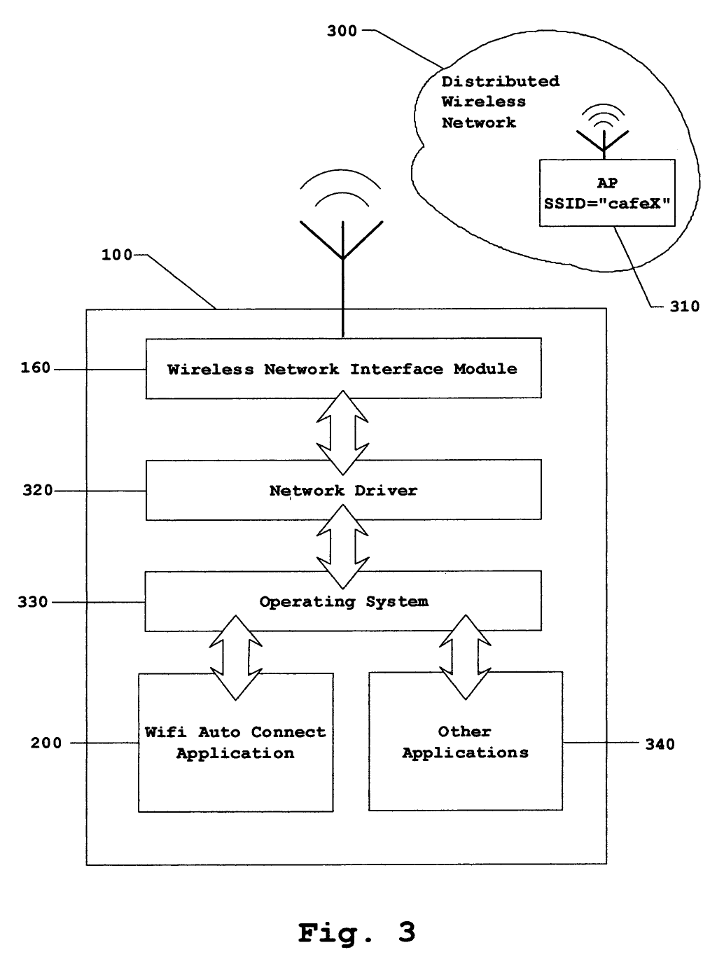

FIG. 3 shows a software block diagram of a typical mobile device 100 which implements an embodiment of the invention. 320 represents the network driver for the wireless network interface module 160. 330 represents the operating system of the mobile device. 200 is the Wifi-Autoconnect application and other applications on the device are represented by block 340. Also shown is the wireless network interface module 160. 300 is the distributed wireless network which may have multiple access points, one of which is depicted by 310.

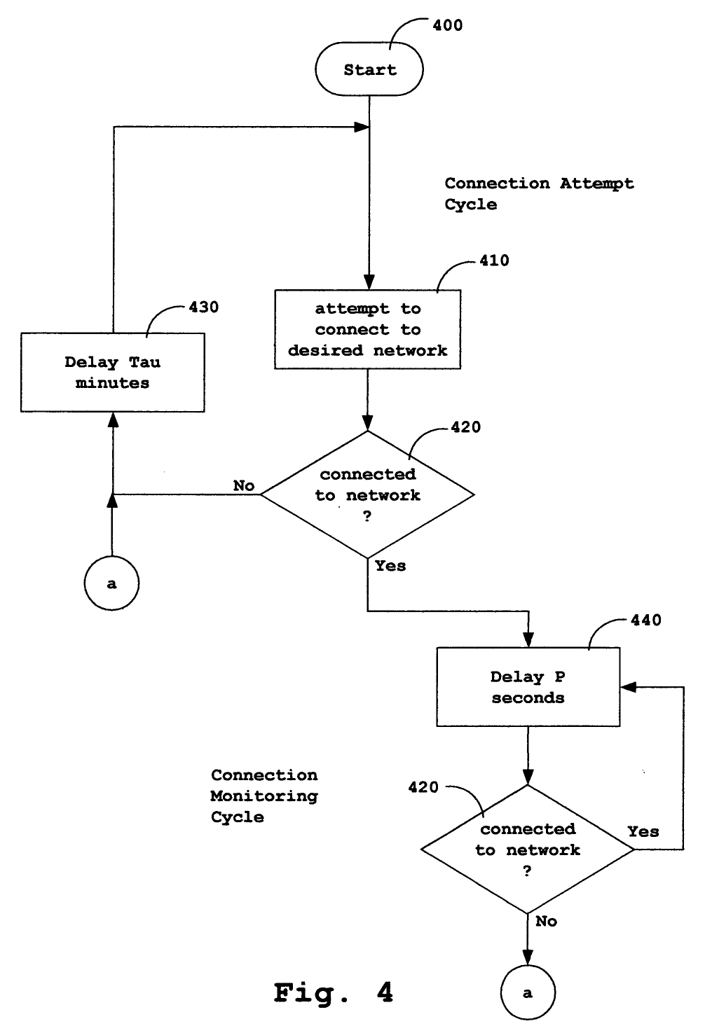

FIG. 4 is a basic flowchart of an embodiment of the invention showing a connection attempt cycle and the connection monitoring cycle. Step 400, labeled “Start”, is an initialization step. Tau 230 is set to five minutes and P 240 is set to sixty seconds. These initial values are illustrative only and may be set according to user preferences. Other settings and variables can/may be initialized in step 400 as well.

Step 410, labeled “attempt to connect to desired network”, this step comprises providing a network identifier or an access point identifier to the wireless network interface module 160. In an 802.11 environment, the network identifier could be an SSID selected from the desired network list 250. In an 802.11 environment the access point identifier could be a BSSID and similarly in a Bluetooth environment, the access point identifier could be a Bluetooth device address. Most 802.11 equipped PDAs today have APIs which provide C language functions that applications can call to control the wireless network interface module 160. An example C language function call is: SetWLANssid(“MYNETWORK”); This function call provides the SSID “MYNETWORK” to the wireless network interface module 160 of the PDA. Typically, at the application level on the mobile device, this is all that is required to effect a wireless network connection attempt. Other connection details might need to be provided to the wireless network interface module 160 such as encryption keys, in order to facilitate a successful wireless network connection. The operating system 330 of a mobile device or another application on the device could provide the network identifier or access point identifier to the wireless network interface module 160 as well.

Step 420, labeled “connected to network?”, this step comprises determining if the mobile device is able to receive network services from a network. Most 802.11 equipped PDAs today have APIs which provide C language functions that applications can call to query the state of the wireless network interface module 160. An example of determining if the mobile device is connected to a wireless network is in the following C language statement: GetWLANssid(*strSSID); If the mobile device is connected to a wireless network, the SSID of the network will be placed in the string variable strSSID. If the mobile device is not connected to a network, the statement will generate an error.

Another example of how to determine if a mobile device is connected to a network is in the following C# language statement: StrConnectedAP=adapter.AssociatedAccessPoint;

If the mobile device is connected to a wireless network, the SSID of the network will be placed in the string variable StrConnectedAP. If the mobile device is not connected to a network, the statement will generate an error. Some APIs come with a specific function which when called will be true if the mobile device is connected to a network and false otherwise. Another example of how to determine if a mobile device is connected to a network is to check if the mobile device has a valid IP address. If the mobile device has a valid IP address, it is connected to a network. Another example of how to determine if a mobile device is connected to a network is to request data from a website on the internet. If valid data is received from the website, the mobile device is connected to a network. This is not an exhaustive list of ways to determine if a mobile device is connected to a network.

Step 430, labeled “Delay Tau minutes”, is typically implemented as a timer set to Tau 230. Tau 230, normally varies between 0.5 and 30 minutes.

Step 440, labeled “Delay P seconds”, is typically implemented as a timer set to P 240. P 240, normally is chosen between 0.1 seconds and 120 seconds.

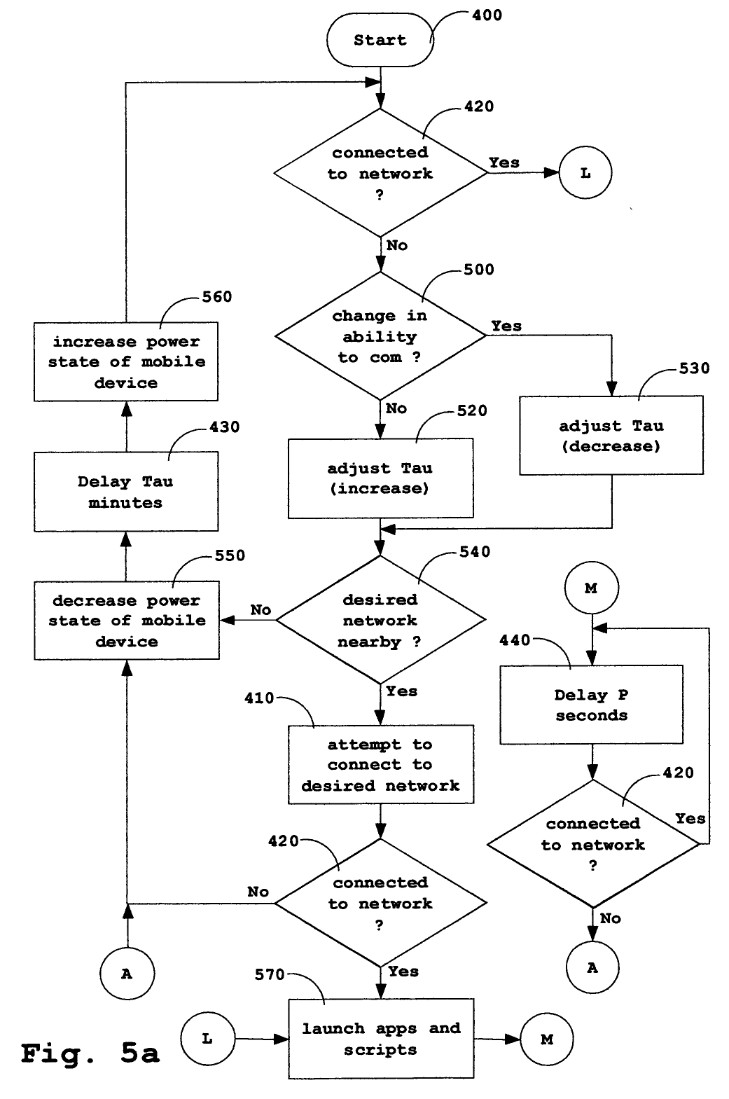

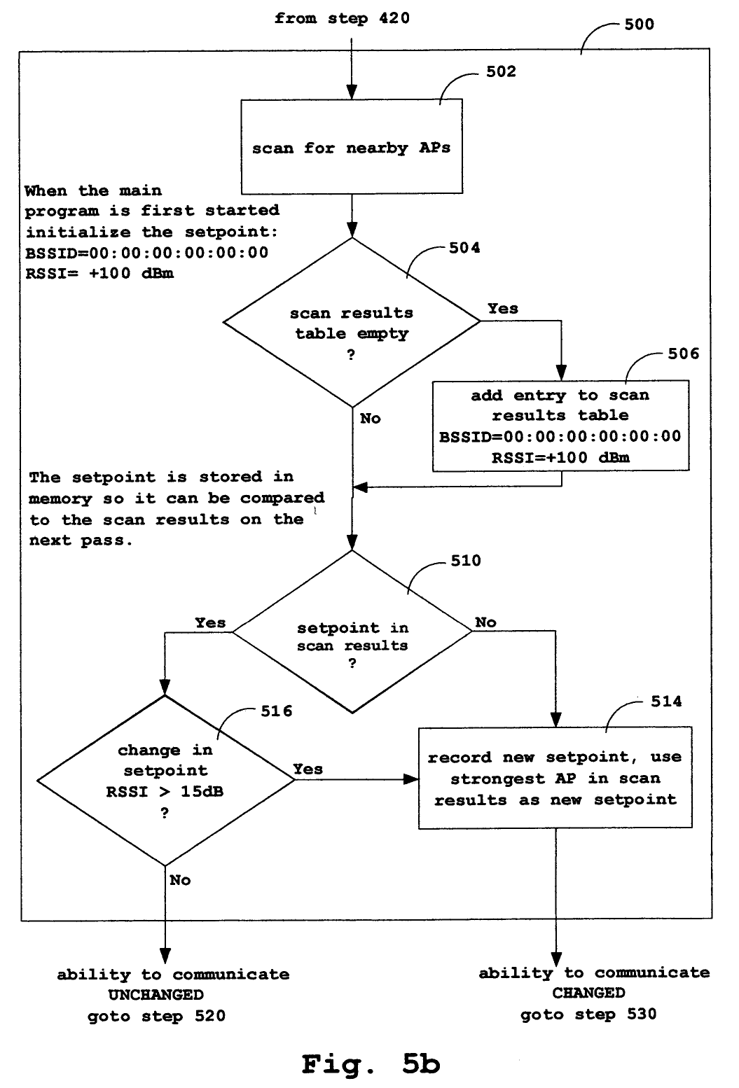

FIG. 5a shows an embodiment of the invention with three key steps added. The first addition on this flowchart is the adjustment of Tau 230 based on the determination that there has been a change in the ability of the mobile device to communicate with an access point. Second, is the added step of launching an application upon connection to a specific network. Finally, the power state of the mobile device is decreased during the delay step 430 and increased after step 430.

Step 500, labeled “change in ability to com?”, this step is where a characteristic of the mobile device 100 is determined. One such characteristic of the mobile device 100 is whether or not there has been a change in the ability of the mobile device to communicate with an access point. An example of how to make such a determination is detailed in FIG. 5b where step 500 comprises steps 502 through 514. Other methods to determine if there has been a change in the ability of the mobile device 100 to communicate with an access point are possible. Other methods to determine a characteristic of the mobile device 100 are possible.

Step 502, labeled “scan for nearby APs” in FIG. 5b, is the step where a scan for nearby access points is performed. The results are stored in the Scan Results Table 210. Included in the results are the BSSIDs and the SSIDs of the access points which responded to the scan request and their respective RSSIs. An example C# language statement which instructs the wireless network interface module 160 to scan is:
APCollection=adapter.NearbyAccessPoints;
The scan results are delivered to the collection APCollection, which can then be processed to get the data to the Scan Results Table 210.

Step 504, labeled “scan results table empty?”, this step is a check to determine if no access points showed up in the scan.

Step 506, labeled “add entry to scan results table BSSID=00:00:00:00:00 RSSI=+100 dBm”, this step adds a placeholder entry to the Scan Results Table 210. This step is only executed if the mobile device 100 is not in range of any wireless access points as determined in Step 504.

Step 510, labeled “set point in scan results?”, this step is a check to determine if the Setpoint 220 appears in the scan results. The Setpoint 220 is typically initialized in Step 400 to BSSID=00:00:00:00:00 RSSI=+100 dBm.

Step 514, labeled “record new Setpoint, use strongest AP”, this step is where a new Setpoint 220 is selected as the access point in the Scan Results Table 210 with the strongest RSSI. Other criteria could be used to choose the Setpoint 220. The Setpoint 220 is typically recorded as the BSSID along with its RSSI at the time of selection but certainly other scan result data could be used as the Setpoint 220.

Step 516, labeled “change in Setpoint RSSI>15 dB?”, in this step the current RSSI of the Setpoint access point is compared to the Setpoint RSSI—if the difference is greater than a threshold, as an example 15 dB, then a new Setpoint is chosen in Step 514. Step 516 is not a requirement for Step 500, but if included it allows Step 500 to have greater sensitivity and it provides some filtering of the scan results. Also, the threshold could be varied based on the RSSI of the Setpoint. For instance, if the Setpoint RSSI is −50 dBm, the threshold could be chosen as 15 dB and if the Setpoint RSSI is −75 dBm, the threshold could be chosen as 10 dB.

Step 520, labeled “adjust Tau(increase)” is shown in FIG. 5a. In this step, Tau 230 is adjusted. Given that the ability of the mobile device 100 to communicate has not changed as determined in step 500, Tau will typically be increased in this step. An example would be to increase Tau 230 to 20 minutes. The adjustment of Tau 230 in step 520 can be tailored to user preferences, for instance, Tau could be increased exponentially to some maximum value or Tau could be adjusted immediately to some maximum value.

Step 530, labeled “adjust Tau(decrease)”. In this step, Tau 230 is adjusted. Given that the ability of the mobile device 100 to communicate has changed as determined in step 500, Tau will typically be decreased in this step. An example would be to reduce Tau by fifty percent until some minimum value was reached, say, 30 seconds. Tau 230 in step 530 could be adjusted on a schedule tailored to user preferences.

Step 540, labeled “desired network nearby?”. In this step, it is determined if a network listed in the Desired Network List 250 is nearby. One way to implement this step is to compare the Desired Network List 250 with the Scan Results Table 210 and check for a match. If one of the networks in the Desired Network List 250 will not respond to a broadcast scan, then it must be detected with an individualized probe request.

Step 550, labeled “decrease power state of mobile device”. In this step, the power consumption of the mobile device is reduced. Some examples are turning off the backlight, reducing the CPU clock frequency, and putting sections of the wireless circuitry into power saving modes. Other ways to reduce the power consumption of the mobile device are of course possible.

Step 560, labeled “increase power state of mobile device”. In this step, the power consumption is set such that the mobile device 100 can at least attempt a connection to a wireless network. Typically, this is an increase in power consumption if in step 550 the power consumption of the mobile device 100 has been reduced. Some examples of increasing the power state of the mobile device 100 are increasing the CPU clock frequency, turning on the backlight and enabling the wireless network interface module 160. Other ways to increase the power consumption of the mobile device are of course possible.

Step 570, labeled “launch apps and scripts”. In this step, typically a login script or application is launched. This handles the situation where one of the networks in the Desired Network List 250 is a “hotspot” which requires a login sequence before granting network services. Other types of applications could be launched in Step 570 as well. Method steps 540, 550, 560 and 570 are optional.

Instructions for carrying out the method steps of the invention may be stored on any suitable media readable by a mobile device. The media may be any media now known or hereafter developed, including ROM or RAM of any kind, and may be conveyed to a mobile device by any suitable means.

Even though the description has examples which are 802.11 oriented, the ription is not to be limited to 802.11. Mobile devices which use other wireless protocols can use the invention as well.

1. A method for automatically connecting a mobile device to a wireless network, the method comprising the steps of:
attempting to connect the mobile device to the wireless network;
determining if the mobile device is connected to the wireless network; and
if the mobile device is not connected to the wireless network, waiting for a first delay period; or
if the mobile device is connected to the wireless network, waiting for a second delay period.

2. The method of claim 1 further comprising the steps of:
determining if there is a change in the ability of the mobile device to communicate with an access point;
adjusting the first delay period if there is a change in the ability of the mobile device to communicate with the access point.

3. The method of claim 1 further comprising the steps of:
determining if there is a change in the ability of the mobile device to communicate with an access point;
increasing the first delay period if there is not a change in the ability of the mobile device to communicate with the access point.

4. The method of claim 2 wherein the step of adjusting the first delay period comprises the step of decreasing the first delay period.

5. The method of claim 2 wherein the step of determining if there is a change in the ability of the mobile device to communicate with an access point comprises the steps of:
Selecting a setpoint access point (“Setpoint”) from a list of access points located during a scan for access points by the mobile device and recording the BSSID of the Setpoint;
determining if the Setpoint BSSID is in the scan results table produced during a subsequent scan for access points by the mobile device, whereby if the Setpoint BSSID is in the scan results table, the ability of the mobile device to communicate with an access point is determined to have not changed, if the Setpoint BSSID is not in the scan results table, the ability of the mobile device to communicate with an access point is determined to have changed.

6. The method of claim 2 wherein the step of determining if there is a change in the ability of the mobile device to communicate with an access point comprises the steps of:
Selecting a setpoint BSSID (“Setpoint BSSID”) from a list of BSSIDs located during a scan for access points by the mobile device and recording a baseline received signal strength indicator (“RSSI”) of the Setpoint;
Measuring the RSSI of the Setpoint during a subsequent scan for access points by the mobile device, and determining if the measured RSSI has changed beyond a predetermined threshold when compared to the baseline RSSI, whereby if the change in the measured RSSI is greater than the threshold, then the ability of the mobile device to communicate with an access point is determined to have changed, if the change in the measured RSSI is less than the threshold then the ability of the mobile device to communicate with an access point is determined to have not changed.

7. The method of claim 6 wherein the Setpoint is identified by its BSSID or its service set identifier (“SSID”).

8. The method of claim 6 wherein the predetermined threshold is in the range of 3 decibels to 20 decibels.

9. The method of claim 2 wherein said step of determining if there is a change in the ability of the mobile device to communicate with an access point comprises the steps of:
determining if the mobile device has moved;
if the mobile device has moved it is determined that the ability of the mobile device to communicate with an access point has changed;
if the mobile device has not moved it is determined that the ability of the mobile device to communicate with an access point has not changed.

10. The method of claim 1 wherein the step of attempting to connect the mobile device to the wireless network comprises the steps of:
determining if the wireless network is nearby the mobile device;
attempting to connect the mobile device to the wireless network.

11. The method of claim 1 wherein the step of waiting for the first delay period comprises the steps of:
decreasing the power state of the mobile device;
waiting for the first delay period;
increasing the power state of the mobile device;

12. The method of claim 1 wherein the step of determining if the mobile device is connected to the wireless network further comprises launching an application if it is determined the mobile device is connected to the wireless network.

13. The method of claim 2 wherein the first delay period is in the range of 0.5 minutes to 30 minutes.

14. The method of claim 1 wherein the second delay period is in the range of 0.1 seconds to 1000 seconds.

15. A method for determining if a mobile device has moved, the method comprising the steps of:
selecting a setpoint BSSID (“Setpoint BSSID”) from a list of BSSIDs located during a scan for access points by the mobile device and recording a baseline received signal strength indicator (“RSSI”) of the Setpoint; and
measuring the RSSI of the Setpoint during a subsequent scan for access points by the mobile device, and determining if the measured RSSI has changed beyond a predetermined threshold when compared to the baseline RSSI, whereby if the change in the measured RSSI is greater than the threshold, then the mobile device is determined to have moved, if the change in the measured RSSI is less than the threshold then the mobile device is determined to have not moved.

16. A method of operating a mobile device in connection with one or more wireless telecommunications networks, the method comprising the steps of:
initiating a connection attempt cycle including plural connection attempts spaced apart by time periods; determining a characteristic of the mobile device; and
varying the time periods between connection attempts according to the determined characteristic.

17. The method of claim 16 in which the characteristic of the mobile device is whether the mobile device has changed position since making a previous connection attempt.

18. The method of claim 17 in which the characteristic of the mobile device is the RSSI received by the mobile device.

19. A wireless enabled mobile device or media readable by a wireless enabled mobile device, the wireless enabled mobile device or media readable by a wireless enabled mobile device being configured to carry out the method steps of claim 1.

20. A wireless enabled mobile device or media readable by a wireless enabled mobile device, the wireless enabled mobile device or media readable by a wireless enabled mobile device being configured to carry out the method steps of claim 16.
